(19) United States
(12) Patent Application Publication
(10) Pub. No.: US 2007/0151750 A1
(43) Pub. Date: Jul. 5, 2007

(54) Flexible sleeve for extension cord

(76) Inventor: Charles Edward Dean, Livingston, TX (US)

Correspondence Address: Gregory M. Luck, 11507 Del Monte, Houston, TX, 77077, US

(21) Appl. No.: 11/323,921

(22) Filed: Jan. 3, 2006

(51) Int. Cl. H01B 7/24

(52) U.S. Cl. 174/136

(57) ABSTRACT

The invention generally comprises a flexible sleeve or sheath, which is adapted to substantially enclose the body of an extension cord while allowing the free ends of the cord to extend from the sleeve. The sleeve moves with the cord in all spatial dimensions, including maintaining coverage of the cord at both rest and in an elongated or stretched position. The sleeve is intended to reduce wear cause by abrasion of the cord as well as entanglement or over-extension (deformation) of the cord.

### BACKGROUND OF THE INVENTION

1. Field of the Invention

The present invention generally relates to a sleeve adapted for use with extension cords. More specifically, the present invention is directed to a flexible sleeve, which may be applied around an extension cord to reduce the abrasion of such cord occasioned by vibration or entangling of the cord.

2. Description of the Prior Art

Communication and battery charging devices installed within the cab of a car or truck are usually provided with a handset or mike connected to the receiving unit by an extension cord. Typically this cord is formed in the shape of an elongated helix so that it assumes a minimum length when in a non-extended position but which may be elongated when the handset is extended away from the receiving unit.

Such flexible extension cords, while accomplishing space savings in the environment of their intended application, also present a number of disadvantages. One such disadvantage is the detrimental, abrasive effect of such cord as it passes over the dash or other surfaces within its surrounding area. Over time, this abrasion both significantly mars such surfaces as well as causes damage to the cord itself, which ultimately reduces its serve life.

Another disadvantage is the tendency of the cord to overly elongate, kink and/or knot over time. This tendency further serves to reduce the service life of the extension cord and may further serve to damage the receiving unit itself.

The present invention addresses one or more of the disadvantages presented by extension cords, and especially helical extension cords, which are commonly used in an environment prone to motion and vibration.

### SUMMARY OF THE INVENTION

The present invention addresses the above and other disadvantages presented by extension cords, and especially helical extension cords, which are commonly used in an environment prone to motion and vibration.

The invention generally comprises a flexible sleeve, which is adapted to substantially enclose the body of the extension cord while allowing the free ends of said cord to extend from the sleeve. The embodiments herein comprise a sleeve that substantially covers the cord when at rest, i.e., not elongated or extended. For cords that are expandable or stretchable the sleeve should expand and/or stretch to maintain coverage as the cord expands (stretches) and contracts.

In one embodiment, the sleeve is formed of an inner and outer layer defining an annular space therebetween. A resilient material may be disposed in the annular space. This resilient filler material acts to absorb the impact of the cord against those surfaces it may contact as a result of abrasion or movement in the vehicle.

In one embodiment, the sleeve comprises a non-tubular shape that may be “rolled” to enclose an extension cord. Alternatively, the sleeve may be manufactured with an internal diameter to allow the free end of a suitable “disconnected” cord to be pulled through the sleeve. These and other embodiments of the present invention, as well as their features and advantages, will become apparent with reference to the following detailed description.

### BRIEF DESCRIPTION OF THE DRAWINGS

A better understanding of the present invention can be obtained when the following detailed description of the preferred embodiment is considered in conjunction with the following drawings, in which:

FIG. 1 is an illustration of a generic device having an extension cord enclosed in a sleeve in accordance with the principles of the present invention,

FIG. 2 is an illustration of an extension cord and a sleeve before enclosure in accordance with the principles of the present invention,

FIG. 3 is an illustration of an extension cord enclosed in a sleeve in accordance with the principles of the present invention,

FIG. 4 is a cross sectional view of an extension cord enclosed in a sleeve in accordance with the principles of the present invention,

FIG. 5 is an illustration of an extension cord enclosed in a zipper sleeve in accordance with the principles of the present invention,

FIG. 6 is a cross sectional view of an extension cord enclosed in a zipper sleeve in accordance with the principles of the present invention,

FIG. 7 is an illustration of an extension cord enclosed in a Velcro sleeve in accordance with the principles of the present invention,

FIG. 8 is an illustration of an extension cord enclosed in a tapered sleeve in accordance with the principles of the present invention,

FIG. 9 is an illustration of an extension cord enclosed in a sleeve comprising snaps in accordance with the principles of the present invention, and

FIG. 10 is a cross sectional view of an extension cord enclosed in a sleeve comprising snaps in accordance with the principles of the present invention.

### NOTATION AND NOMENCLATURE

In the following discussion and in the claims, the term “extension cord” and/or “cord” are intended to be used interchangeably. The term “extension” is intended only as descriptive of a cord or other generally like structure that allows an extension from one space to some other space. No limitation or restriction is intended with respect to any particular type of cord or like structure.

### DETAILED DESCRIPTION OF THE PREFERRED EMBODIMENTS

Embodiments of the present invention are described herein with the understanding that the present disclosure is to be considered an exemplification of the principles of the invention and is not intended to limit the invention to that illustrated and described. The present invention is susceptible to embodiments of different forms or order and should not be interpreted to be limited to the particular structures or compositions contained herein. Terms are intended to have their broadest plain and customary meaning as understood from general dictionaries unless otherwise specifically stated herein.

The invention generally comprises a flexible sleeve or sheath, which is adapted to substantially enclose the body of the extension cord while allowing the free ends of said cord to extend from the sleeve. The sleeve is intended to reduce wear cause by abrasion of the cord as well as entanglement or over-extension (deformation) of the cord. The embodiments herein comprise a sleeve that substantially covers the cord when at rest, i.e., not elongated or extended. For cords that are expandable or stretchable the sleeve should expand and/or stretch to maintain coverage as the cord expands (stretches) and contracts.

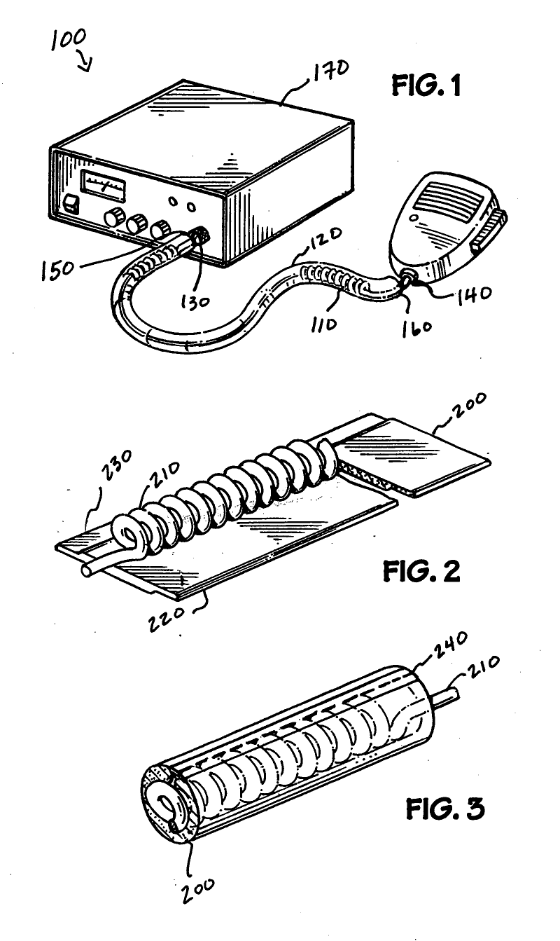

The present invention may be seen by reference to FIGS. 1-10. FIG. 1 illustrates a typical electronic device 100 comprising an extension cord 110, sleeve 120, device 170 and attachment 180. The present invention is limited only by the claims set forth herein and is not intended to be limited to or for use on any particular device. A citizens band radio is shown only for illustrative purposes. Accordingly, the extension cord 110 as shown is common in mobile telephones, citizen band radios, mobile phone chargers, and the like. Also, electronic device 100 may be a mechanical device and may be located in any space in which the extension cord 110 may cause damage, e.g., due to abrasion with surrounding surfaces over time.

Extension cord 110 is operatively connected, coupled or otherwise attached to device 170 at a first end 130 of the extension cord via any means known or used in the art. Likewise, extension cord 110 is operatively connected, coupled or otherwise attached to an attachment 180 (as shown a mike/speaker) at a second end 140 of the extension cord via any means known or used in the art. The body of cord 110 is formed in a familiar helical or spiral configuration, which allows its elongation in use but which retracts to a shorter, undistorted shape. Although shown having a helical or spiral shape, such a shape is not critical to the invention of required.

Sleeve 120 comprises an elongated body, which may be tailored to a length and diameter to match the helical cord 110. Sleeve 120 should preferably substantially cover cord 110 when at rest, i.e., not elongated or extended, as well as when cord 110 is fully elongated or extended. Cords that are not expandable (not shown) sleeve 120 should substantially cover the length of cord 110. For example, FIG. 1 illustrates that sleeve 120 encloses the entire length of cord 110 as it enters at first end 130 via a first sleeve opening 150 and terminates at second end 140 through a second sleeve opening 160.

Accordingly, sleeve 120 may be comprised of any suitable elastic or non-elastic material. Any suitable material is sufficient in that the composition of the sleeve 120 is not critical to the invention provided that it allows for the objectives of the sleeve in the spirit of the invention. For example, a non-elastic material should be of sufficient length to substantially cover the elongated cord 110 and be capable of contracting (e.g., accordion mechanism). Suitable materials may include nylon, polypropylene, cotton, synthetic or natural materials, cloth or fabric, tubular webbing material, polymeric materials and the like, including combinations thereof.

In one embodiment, sleeve 120 comprises a preformed design (e.g., tubular, sheath sock type, etc) and may be slidably mounted on the desired cord via first and second openings 150 and 160 provided that the cord ends 130 and/or 140 allow such a mounting. In another embodiment, the sleeve may comprise a non-tubular shape at rest that may be “rolled” to enclose an extension cord.

FIG. 2 illustrates a sleeve material 200 that can be substantially non-tubular at rest having two substantially parallel or otherwise complimentary edges 220 and 230. Cord 210 is enclosed within sleeve 200 by “rolling” sleeve 200 such that edge 220 meets edge 230 and secured in place. FIG. 3 illustrates sleeve 200 fitted around cord 210. Edges 220 and 230 are secured in place to form a connective seam 240. Sleeve 200 may be secured using any suitable fastener mechanism, e.g., Velcro fasteners, snaps, zipper, buttons, adhesive, hook and loop, and the like, including combinations thereof.

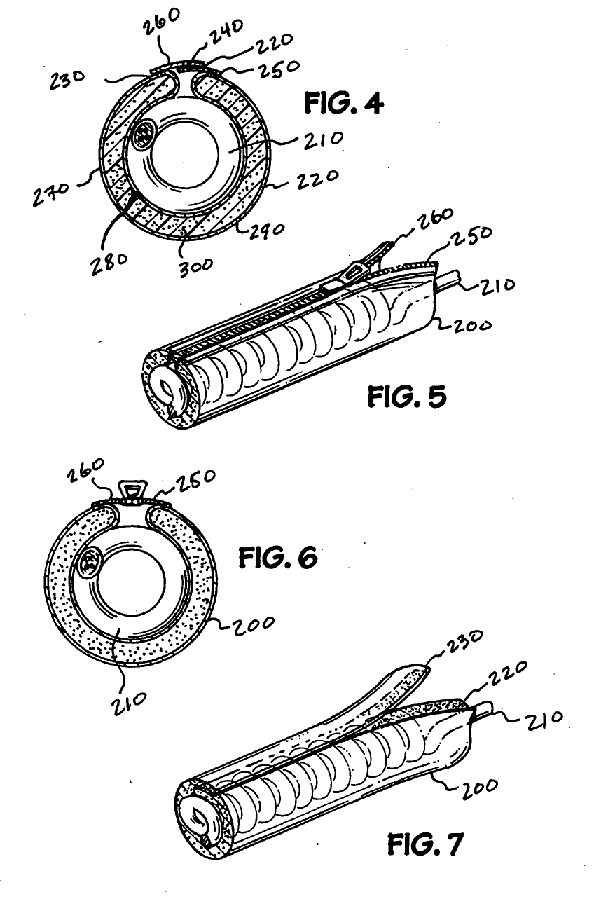

FIG. 4 shows a cross-sectional view of sleeve 200 fitted around cord 210. As shown, it can be appreciated that sleeve 200 may comprise an inner layer 280 and outer layer 270 defining an annular space 290 therebetween. Alternatively, sleeve 200 may comprise an inner sheath 270 and a separate outer covering 280 defining an annular space 290 therebetween. A filler material 300 may be disposed in the annular space 290. The filler material 300 may comprise any suitable material. The composition of the filler material 300 is not critical to the invention, but a durable resilient material is preferred. Suitable filler material 300 may comprise foam, Styrofoam, polymeric materials, natural an/or synthetic materials, quilting material, cloth, trapped air, gel or the like, including combinations thereof. The filler material may create a cushion between the cord 210 and the outer surface 270 of sleeve 200 as it contacts surfaces (not shown) within its immediate operating environment.

FIG. 4 also shows 220 and 230 secured in place around cord 210 to form connective seam 240 via strips 250 and 260. As shown, strips 250 and 260 are additional pieces of material attached to the outer surface 270 of edges 220 and 230, respectively. Suitable fasteners (such as those previously described) may be located on strips 250 and 260 such that they align as necessary to form a secure connection that maintains sleeve 200 fitted around cord 210.

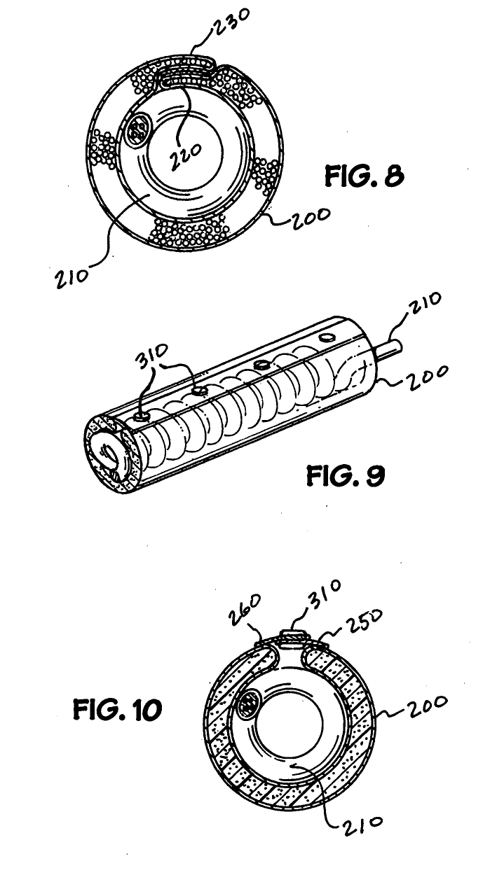

Examples of specific fasteners are illustrated in FIGS. 5, 6, 9 and 10. FIGS. 5 and 6 illustrate full body and cross-sectional views of sleeve 200 having a zipper fastener attached as strips 250 and 260. FIG. 9 and 10, likewise, illustrate full body and cross-sectional views of sleeve 200 having snaps 310 attached on strips 250 and 260. Once secure, strips 250 and 260 form connective seam 240. Depending upon the type of cord 210 and sleeve 200, the fasteners used to secure connective seam 240 should be capable maintaining the seam 240 with any expansion and/or movement required by use of the device.

Alternatively, fasteners may be directly incorporated onto or as an integral part of the sleeve material. For example, edges 220 and 230 may have suitable fasteners, such as Velcro or adhesive, to allow for secure connection upon the direct contact of the two edges. In yet another embodiment, FIGS. 7 and 8 illustrate that edges 220 and 230 may be tapered or beveled or otherwise designed to create a form-fitting seam 240. A suitable fastener may be affixed and/or an integral part of the beveled or tapered edges to form a secure seam 240.

Still another embodiment comprises an extension cord comprising a helical or spiral shaped cord having a first and second end, wherein at least one end is operatively connectable to a secure device; and an integrated sleeve enclosed around said cord adapted for maintaining an enclosure around a substantial length of said cord during normal operations, wherein said sleeve comprises an annulus defined by an inner surface and outer surface, said annulus at least partially comprising a shock absorbent material, such as described previously herein.

The sleeve may further comprise a means for removing said sleeve from said cord. Suitable means have been adequately described in association with other embodiments herein and include strips and/or fasteners that allow for securing the sleeve around the cord to form a connective seam. Suitable fasteners are selected from the group consisting of velcro, buttons, snaps, zippers, adhesive, tongue and groove mechanisms and combinations thereof. Also as with other embodiments, suitable materials for the sleeve comprise nylon, polypropylene, cotton, a natural fiber, a synthetic fiber, cloth, a polymeric material, and combinations thereof, wherein some are elastic and some non-elastic. Alternatively, the sleeve may be permanently affixed to the cord preventing removal.

While preferred embodiments of this invention have been shown and described, modification thereof can be made by one skilled in the art without departing from the spirit or teaching of this invention. The embodiments described herein are exemplary only and are not limiting. Many variations and modifications of the system and apparatus are possible and are within the scope of this invention. Accordingly, the scope of protection is not limited to the embodiments described herein, but is only limited by the claims, which follow, the scope of which shall include all equivalents of the subject matter of the claims.

What is claimed is:

1. A sleeve adapted for use with a cord comprising:
a cylindrical body defining a base therethrough,
said body comprising an inner surface and separate outer surface, where said inner and outer surfaces define an annulus therebetween,
said annulus being at least partially filled with a filler material, and
said base being adapted to fit about said cord.

2. The sleeve of claim 1 wherein said base may be accessed by way of opening formed along the length of said sleeve to allow the insertion of said cord.

3. The sleeve of claim 2 where said opening may be closed by way of a fastener.

4. The sleeve of claim 3 where said fastener is a zipper.

5. The sleeve of claim 3 wherein the fastener is Velcro.

6. The sleeve of claim 1 wherein the filler material comprises a closed cell foam.

7. The sleeve of claim 1 wherein the filler material comprises a Styrofoam.

8. The sleeve of claim 1 wherein the filler material comprises a gel.

9. The sleeve of claim 1 wherein the inner surface comprise an inner sheath.

10. The sleeve of claim 9 wherein the outer surface comprises a separate outer covering from the inner sheath.

11. An extension cord comprising:
a helical or spiral shaped cord having a first and second end, wherein at least one end is operatively connectable to a secure device; and
an integrated sleeve enclosed around said cord adapted for maintaining an enclosure around a substantial length of said cord during normal operations,
wherein said sleeve comprises an annulus defined by an inner surface and outer surface,
said annulus at least partially comprising a shock absorbent material.

12. The cord of claim 11 wherein the sleeve further comprises means for removing said sleeve from said cord.

13. The cord of claim 12 wherein said means comprises a connective seam comprising fasteners.

14. The cord of claim 13 wherein the fasteners are selected from the group consisting of Velcro, buttons, snaps, zippers, adhesive, tongue and groove mechanisms and combinations thereof.

15. The cord of claim 11 wherein the sleeve comprises a material selected from the group comprising nylon, polypropylene, cotton, a natural fiber, a synthetic fiber, cloth, a polymeric material, and combinations thereof.

16. The cord of claim 11 wherein the sleeve comprises an elastic material.

17. The cord of claim 11 wherein the sleeve is affixed to the cord preventing removal.

18. A sleeve adapted for use with a flexible cord comprising:
two or more complimentary edges capable of forming a connective seam and a first a second opening,
an inner surface comprising a tubular sheath inner core,
an outer surface comprising a separate outer covering,
one or more fasteners proximately located along at least one of the complimentary edges, and
a filler material,
wherein the filler material is located in an annulus formed by the inner surface and outer surface.

19. The sleeve of claim 18 wherein the flexible cord comprises a helical or spiral shaped.

20. The sleeve of claim 19 wherein the cord is associated with either a citizens band radio mike or a battery charger.
